(19) United States
(12) Patent Application Publication
(10) Pub. No.: US 2026/0270418 A1
(43) Pub. Date: Sep. 10, 2026

(54) TEMPLATE-BASED FILTERING FOR INTRA PREDICTION

(71) Applicant: InterDigital CE Patent Holdings, SAS, Paris (FR)

(72) Inventors: Karam NASER, Cesson-Sevigne (FR); Thierry DUMAS, Cesson-Sevigne (FR); Fabrice URBAN, Cesson-Sevigne (FR); Philippe BORDES, Cesson-Sevigne (FR)

(21) Appl. No.: 18/873,241

(22) PCT Filed: Jun. 22, 2023
(86) PCT No.: PCT/EP2023/067060

§ 371 Date: Dec. 9, 2024

(30) Foreign Application Priority Data
Jul. 1, 2022 (EP) 22305977.5
Jan. 31, 2023 (EP) 23305119.2

(51) Int. Cl. H04N 19/117; H04N 19/105; H04N 19/159; H04N 19/176; H04N 19/82

(52) U.S. Cl. CPC H04N 19/117; H04N 19/105; H04N 19/159; H04N 19/176; H04N 19/82

(57) ABSTRACT

In one implementation, the prediction of a block is filtered using a filter learned on a template. To learn the filter, a first template is generated from a set of decoded samples in an area neighboring to the current block, and a second template is generated from a set of predicted samples in the same neighboring area, where the set of predicted samples are obtained based on the intra prediction mode used to predict the current block. The filter parameters are calculated by minimizing a loss function between the set of decoded samples and a set of filtered predicted samples. To reduce the computation complexity, the intra filtering may be only enabled when the intra prediction mode is from the MPM list, is obtained from TIMD or DIMD, or if at least an intra mode in the template area is a close neighbor to the current intra prediction mode.

### TECHNICAL FIELD

The present embodiments generally relate to a method and an apparatus for intra prediction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to one embodiment, a method of video decoding is presented, comprising: obtaining an intra prediction mode for a block to be decoded in a picture; obtaining a prediction block for said block based on said intra prediction mode for said block; obtaining a set of decoded samples in an area neighboring to said block; obtaining a set of predicted samples in said area neighboring to said block; obtaining one or more filter parameters for a filter based on said set of decoded samples and said set of predicted samples in said area neighboring to said block; applying said filter to said prediction block for said block to form a filtered prediction block for said block; and decoding said block based on said filtered prediction block for said block.

According to another embodiment, a method of video encoding, comprising: obtaining an intra prediction mode for a block to be encoded in a picture; obtaining a prediction block for said block based on said intra prediction mode for said block; obtaining a set of reconstructed samples in an area neighboring to said block; obtaining a set of predicted samples in said area neighboring to said block; obtaining one or more filter parameters for a filter based on said set of reconstructed samples and said set of predicted samples in said area neighboring to said block; applying said filter to said prediction block for said block to form a filtered prediction block for said block; and encoding said block based on said filtered prediction block for said block.

According to another embodiment, an apparatus for video decoding is provided, comprising one or more processors and at least one memory coupled to said one or more processors, wherein said one or more processors are configured to: obtain an intra prediction mode for a block to be decoded in a picture; obtain a prediction block for said block based on said intra prediction mode for said block; obtain a set of decoded samples in an area neighboring to said block; obtain a set of predicted samples in said area neighboring to said block; obtain one or more filter parameters for a filter based on said set of decoded samples and said set of predicted samples in said area neighboring to said block; apply said filter to said prediction block for said block to form a filtered prediction block for said block; and decode said block based on said filtered prediction block for said block.

According to another embodiment, an apparatus for video encoding is provided, comprising one or more processors and at least one memory coupled to said one or more processors, wherein said one or more processors are configured to: obtain an intra prediction mode for a block to be encoded in a picture; obtain a prediction block for said block based on said intra prediction mode for said block; obtain a set of reconstructed samples in an area neighboring to said block; obtain a set of predicted samples in said area neighboring to said block; obtain one or more filter parameters for a filter based on said set of reconstructed samples and said set of predicted samples in said area neighboring to said block; apply said filter to said prediction block for said block to form a filtered prediction block for said block; and encode said block based on said filtered prediction block for said block.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates 67 core intra prediction modes in VVC and ECM.

FIG. 5 illustrates samples used to compute the horizontal and vertical gradients.

FIGS. 6A, 6B and 6C illustrate a template of the current luminance CB to be encoded/decoded and decoded reference samples of the template.

FIG. 7 illustrates input to the spatial 5-tap component of the filter when CCCM predicts the current chrominance CB to be encoded/decoded from the potentially downsampled version of the reconstructed luminance CB that is collocated with the current chrominance CB.

FIG. 8A illustrates a reconstructed luminance CB that is collocated with the current W×H chrominance CB to be encoded/decoded, FIG. 8B illustrates the downsampled reconstructed luminance CB and the luminance reference area, and FIG. 8C illustrates its chrominance reference area.

FIG. 9A and FIG. 9B respectively illustrate the template of decoded reference samples and template of predicted samples of the current W×H luminance CB to be encoded/decoded.

FIG. 10 illustrates two-step template-based filtering of the luma intra prediction on the encoder side, for the current luminance CB predicted in the intra mode, according to an embodiment.

FIG. 11 illustrates two-step template-based filtering of the luma intra prediction on the decoder side, for the current luminance CB predicted in the intra mode, according to an embodiment.

FIG. 12 illustrates a template shape for TIMD and possibly for deriving the intra filter.

FIG. 13A and FIG. 13B illustrate overlapping blocks in the template.

FIG. 14 illustrates two-step template-based filtering of the luma intra prediction on the decoder side, for the current luminance CB predicted in intra, according to an embodiment.

FIG. 15 illustrates two-step template-based filtering of the luma intra prediction on the encode side, for the current luminance CB predicted in intra via TIMD, according to an embodiment.

FIGS. 16A, 16B and 16C illustrate an example of TIMD with two derived intra prediction modes.

FIG. 17 illustrates two-step template-based filtering of the luma intra prediction on the decoder side, for the current luminance CB predicted in intra via TIMD, according to an embodiment.

### DETAILED DESCRIPTION

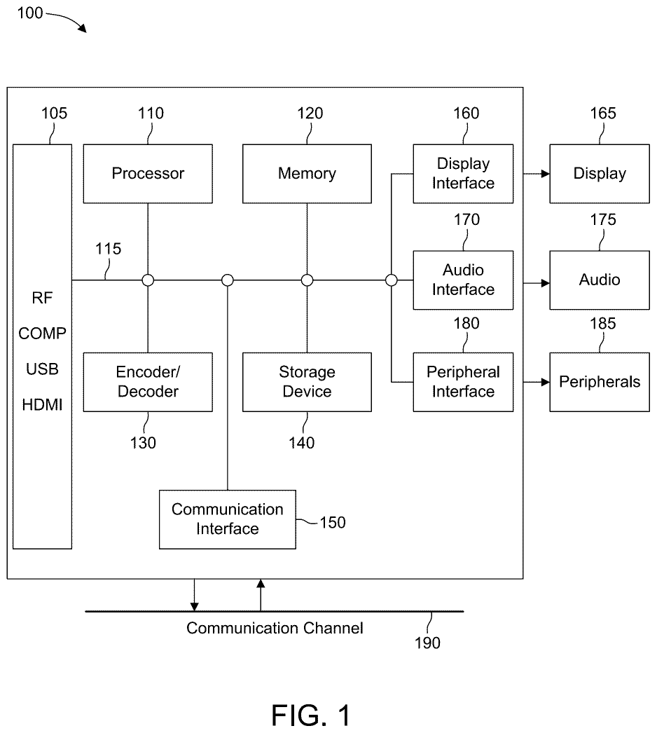

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

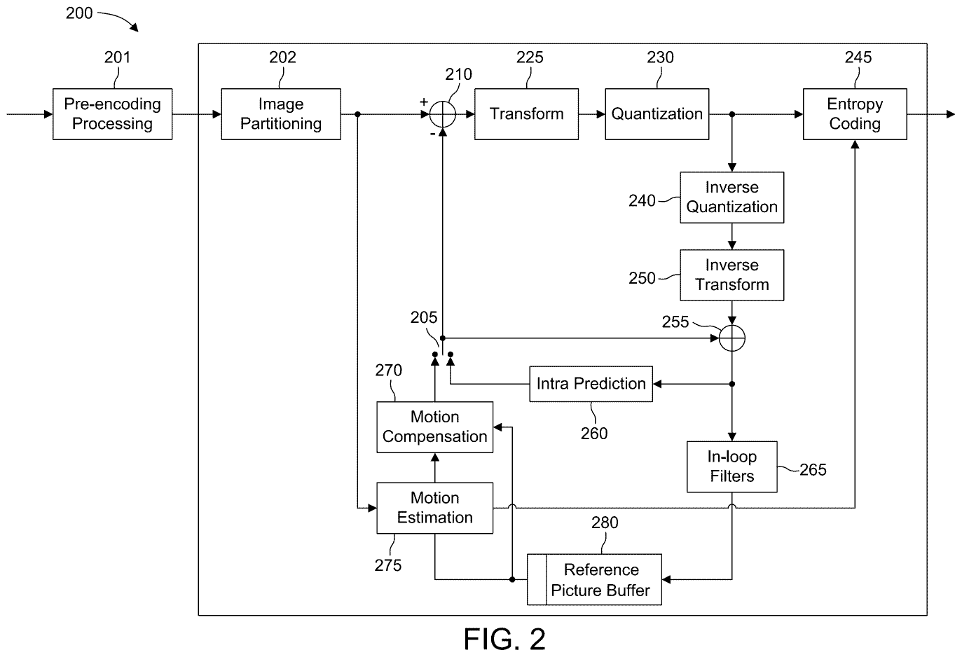

FIG. 2 illustrates an example video encoder 200, such as a a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

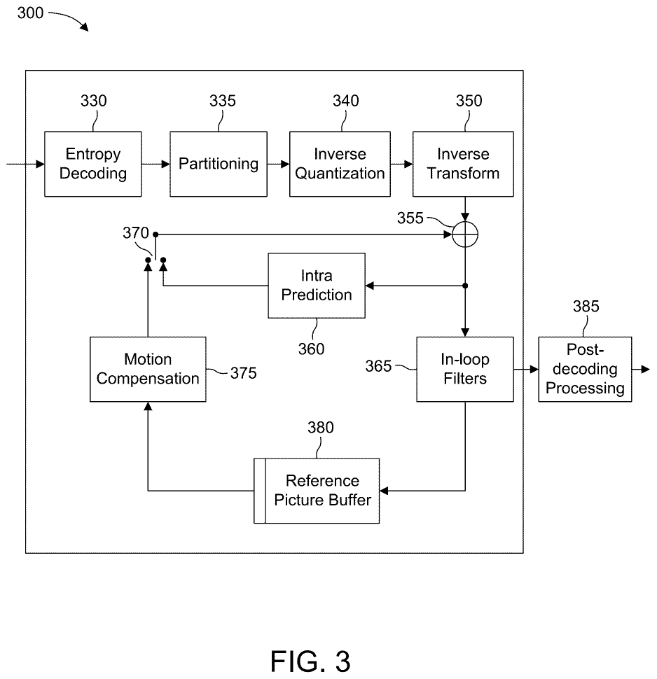

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

This disclosure relates to intra prediction. In the follows, we first present the main features of the core intra prediction in the Enhanced Compression Model (ECM), the compression model currently studied in JVET (Joint Video Experts Team). Then, some template-based tools inside the intra prediction in ECM are detailed.

Core 67 Intra Prediction Modes Inherited from Versatile Video Coding (VVC)

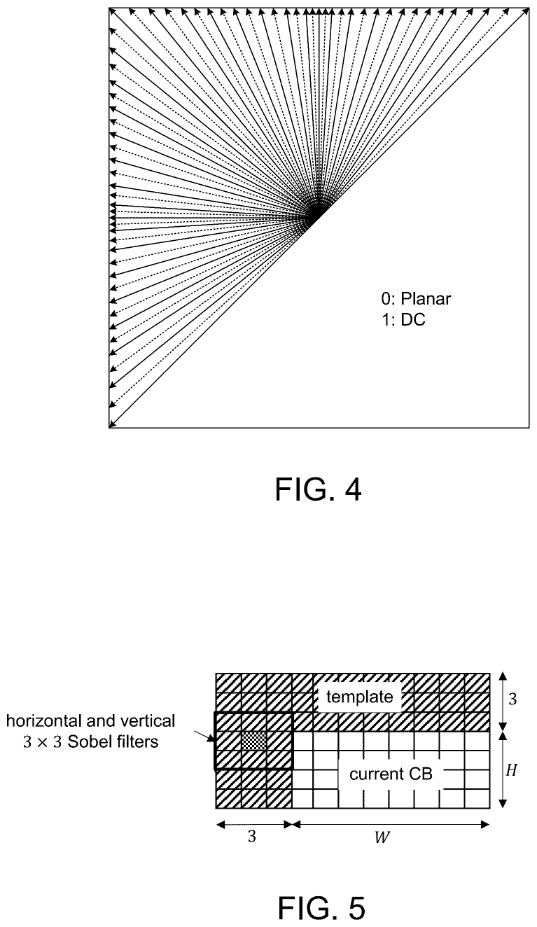

To capture the arbitrary edge directions presented in natural video, VVC features 65 directional intra prediction modes. Moreover, for predicting blocks with smoothly varying textures, VVC uses the PLANAR and DC modes. These 67 core intra prediction modes are applied to all block sizes and in both luma and chroma intra predictions. FIG. 4 depicts these 67 core intra prediction modes. For a given luma block and for a given directional intra prediction mode, under specific conditions, Position Dependent intra Prediction Combination (PDPC) filters the prediction of this block using the decoded reference samples located on the opposite side of the decoded reference samples extrapolated via this mode. When a given luma block is predicted by either PLANAR or DC, under specific conditions, PDPC filters the prediction using decoded reference samples on the left side of the block and decoded reference samples above the block.

In ECM, the set of core 67 intra prediction modes is inherited from VVC. Intra prediction is refined in ECM:
the four-tap interpolation for a directional intra prediction mode becomes a six-tap interpolation; and
PDPC is supplemented with gradient PDPC.

### Intra Prediction Mode Signaling in ECM

In ECM-4.0, if the intra prediction mode selected to predict the current luminance Coding Block (CB) is neither Decoder Side Intra Mode Derivation (DIMD), nor a Matrix-based Intra Prediction (MIP) mode or Template-based Intra Mode Derivation (TIMD), i.e., it is one of the 67 intra prediction modes shown in FIG. 4, its index is signaled using the Most Probable Mode (MPM) list of the CB. Note that, in the previous consideration, BDPCM, Template-based Intra Prediction (TMP), Intra Block Copy (IBC), and Palette mode are ignored as these tools are activated for specific video sequences exclusively, e.g., screen content.

In ECM-4.0, the generic MPM list is decomposed into a list of six primary MPMs and a list of sixteen secondary MPMs. The generic MPM list is built by sequentially adding candidate intra prediction mode indices, from the one most likely being the selected intra prediction mode for predicting the current luminance CB to the least likely one. Note that no redundancy exists in the generic list of MPMs, meaning that it cannot contain two identical intra prediction mode indices.

### Intra Prediction Mode Signaling in Chrominance

When signaling the intra prediction mode selected to predict the current pair of chrominance CBs, that is collocated Cb and Cr CBs, in ECM-4.0, if the Direct Mode (DM) flag equals 1, the four possibilities for the current intra prediction mode index are the index of the PLANAR mode, that of the horizontal mode, that of the vertical mode, and that of the DC mode. To avoid any redundancy, if the DM is one of the four above-mentioned modes, in this set of four modes, the index of the redundant mode is replaced by the index of the vertical diagonal mode. Note that, in ECM-4.0, Cross-Component Linear Model (CCLM) gathers six different intra prediction modes, denoted LM, MMLM, MDLM_L, MDLM_T, MMLM_L, and MMLM_T, whereas, in VVC, CCLM gathers only three intra prediction modes.

### Template-Based Intra Prediction Tools in ECM

### Decoder-Side Intra Mode Derivation (DIMD)

In ECM-4.0, DIMD derives, from the gradients in a template of decoded reference samples of the current luminance CB to be encoded/decoded, the indices of two intra prediction modes that are likely the two best intra prediction modes for predicting the current luminance CB in terms of rate-distortion. Later, the current luminance CB is predicted by blending the two predicted blocks obtained by applying the two derived intra prediction modes with the predicted block obtained by applying PLANAR. The weights involved in the blending are derived from the gradients in this template.

More specifically, for the current luminance CB, the indices of the two intra prediction modes are derived from the gradients in this template. First, a Histogram of Oriented Gradients (HOG) with 65 bins, corresponding to the 65 directional intra prediction modes, are initialized to 0. Then, for each decoded reference sample in the middle row or the middle column of the template of three rows of decoded reference samples above the current luminance CB and three columns of decoded reference samples on its left side, the horizontal and vertical gradients (G_{HOR}, G_{VER}) are calculated and a corresponding HOG of index is incremented by “|G_{HOR}|+G_{VER}|. The indices of the two largest HOG bins are the indices of the two derived intra prediction modes.

### Template-Based Intra Mode Derivation (TIMD)

Like DIMD, for the current luminance CB to be encoded/decoded, TIMD follows a two-step process: an intra prediction mode index derivation step involving a template of decoded reference samples of the current luminance CB and a step in which the current luminance CB is actually predicted.

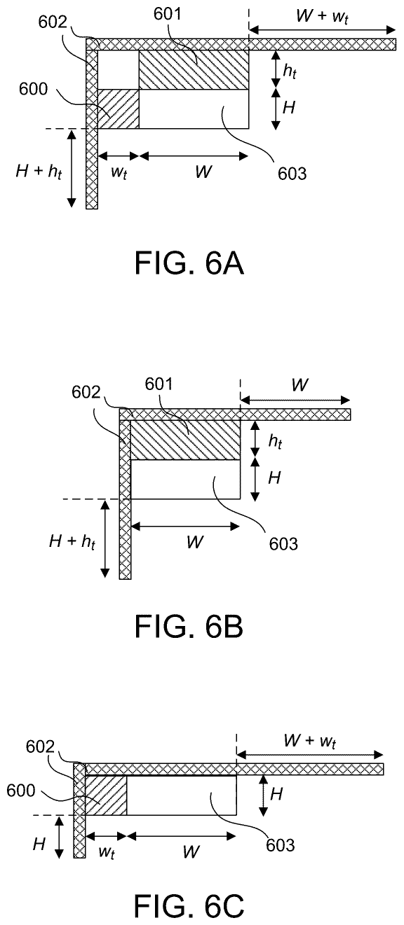

In FIG. 6A, the current W×H luminance CB (603) is surrounded by its fully available template, made of a wₜ×H portion on its left side (600) and a W×hₜ portion above it (601). During the TIMD derivation step, a tested intra prediction mode predicts the template of the current luminance CB from the set of 1+2wₜ+2W+2hₜ+2H decoded reference samples (602) of the template. In ECM-4.0, wₜ equals 2 if W≤8, and wₜ equals 4 otherwise; hₜ equals 2 if H≤8, and hₜ equals 4 otherwise. In FIG. 6B, the current W×H luminance CB (603) is surrounded by its template with only its W×hₜ portion above it (601) available. During the TIMD derivation step, a tested intra prediction mode predicts the template of the current luminance CB from the set of 1+2W+2hₜ+2H decoded reference samples (602) of the template. In FIG. 6C, the current W×H luminance CB (603) is surrounded by its template with only its wₜ×H portion on its left side (600) available. During the TIMD derivation step, a tested intra prediction mode predicts the template of the current luminance CB from the set of 1+2wₜ+2W+2H decoded reference samples (602) of the template.

For a given luminance CB (603) in FIG. 6A, the following modes derivation via TIMD applies the same way on the encoder and decoder sides. For each intra prediction mode in the MPM list of this luminance CB, if needed, supplemented with default modes, the encoder/decoder computes a prediction of the template (600 and 601) of this luminance CB from the decoded reference samples of the template (602), and the SATD between this prediction and the template of this luminance CB is calculated. The two intra prediction modes with the minimum SATDs are selected as the TIMID modes. Note that, for TIMID, the set of directional intra prediction modes is extended from 65 to 129, by inserting a direction between each solid arrow and its neighboring dotted arrow in FIG. 4. This means that the set of possible intra prediction modes derived via TIMD gathers 131 modes.

After retaining two intra prediction modes from the first pass of tests involving the MPM list supplemented with default modes, for each of these two modes, if this mode is neither PLANAR nor DC, TIMID also tests in terms of prediction SATD its two closest extended directional intra prediction modes. Note that, in the above description, it is assumed that the template of the luminance CB does not go out of the bounds of the current frame. In the case where at least one portion of the template of the luminance CB goes out of the bounds of the current frame, those portions are considered as being unavailable as illustrated in FIG. 6B and FIG. 6C.

To predict the current luminance CB via TIMID, the two predictions of the luminance CB via the two TIMID modes resulting from the two passes of tests are fused with weights after applying PDPC. The used weights depend on the prediction SATDs of the two TIMID modes.

### Convolutional Cross-Component Model (CCCM)

In the Exploration Experiment (EE) on top of ECM-4.0, the Convolutional Cross-Component Model (CCCM) predicts the current chrominance CB to be encoded/decoded by applying a convolutional filter to the potentially downsampled version of the reconstructed luminance CB that is collocated with the current chrominance CB. When using chroma sub-sampling, this downsampling is carried out such that the resolution of the downsampled collocated reconstructed luminance CB matches the resolution of the chroma grid.

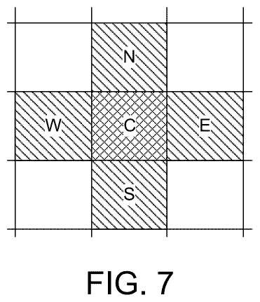

The CCCM convolutional 7-tap filter consists of a 5-tap plus sign shape spatial component, a nonlinear term, and a bias term. The input to the spatial 5-tap component of the filter consists of a center (C) luma sample that is collocated with the current chroma sample to be predicted and its above/north (N), below/south (S), left/west (W), and right/east (E) neighbors, as shown in FIG. 7.

The nonlinear term P is represented as power of two of the center luma sample C and scaled to the sample value range of the content

$$P = ( C * C + midVal ) >> bitDepth$$

where bitDepth represents the pixel bit depth, and midVal represents the middle value of the bit depth range.

For instance, for 10-bit content, it is calculated as

$$P = ( C * C + 512 ) >> 10.$$

The bias term B represents a scalar offset between the input and output. B is set to middle chroma value, e.g., 512 for 10-bit content.

Calling c₀, c₁, c₂, c₃, c₄, c₅, and c₆ the seven coefficients of the 7-tap filter, the current predicted chroma sample “predChromaVal” is expressed as:

$$predChromaVal = clip ( {c}_{0} C + {c}_{1} N + {c}_{2} S + {c}_{3} E + {c}_{4} W + {c}_{5} P + {c}_{6} B )$$

where “clip” clips to the range of valid chroma sample values.

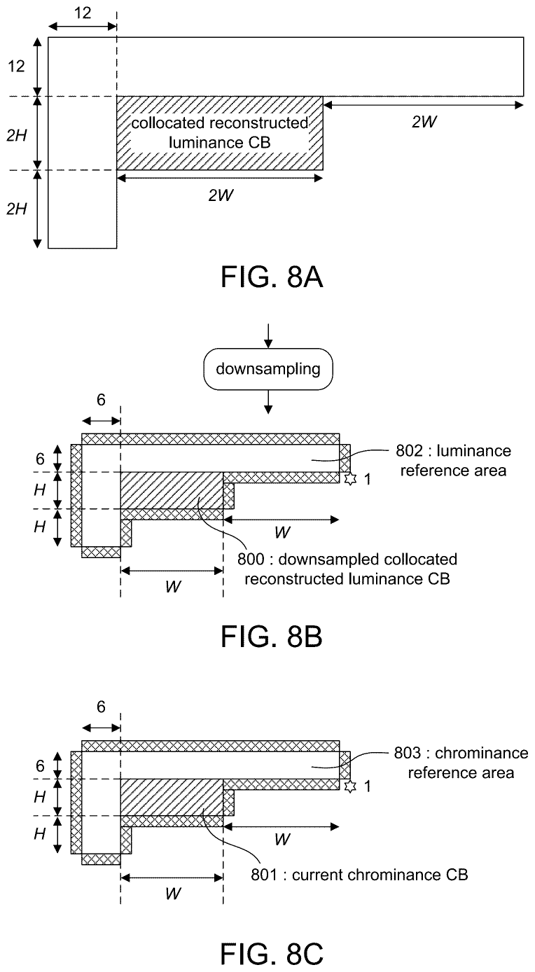

The filter coefficients c₀, c₁, c₂, c₃, c₄, c₅, and c₆ are calculated by minimizing the Mean Squared Error (MSE) between the predicted chroma samples generated by applying the convolutional 7-tap filter to the potentially downsampled version of the reconstructed luma samples in the luminance reference area (802) and the reconstructed chroma samples in the chrominance reference area (803) as shown in FIGS. 8B and 8C.

FIG. 8A illustrates the reconstructed luminance CB that is collocated with the current W×H chrominance CB (801) to be encoded/decoded. FIG. 8B illustrates the downsampled reconstructed luminance CB (800) that is collocated with this chrominance CB, and the luminance reference area (802) in the case of chroma format 4:2:0, i.e., before encoding, the resolution of each chrominance channel is divided by 2 via sub-sampling. FIG. 8C illustrates its chrominance reference area (803).

The luminance reference area (802) consists of six rows/columns of potentially downsampled reconstructed luma samples above and on the left side of the potentially downsampled version of the reconstructed luminance CB (800) that is collocated with the current chrominance CB. The chrominance reference area (803) consists of six rows/columns of reconstructed chroma samples above and on the left side of the current chrominance CB (801) to be encoded/decoded. Each reference area extends one CB width to the right and one CB height below the CB boundaries. Each reference area is adjusted to include only available decoded reference samples. The extensions to the areas, filled in black in FIG. 8, are needed to support the side samples of the plus shaped spatial filter and are padded when in unavailable areas.

The MSE minimization is performed by calculating an autocorrelation matrix for the luma input and a cross-correlation vector between the luma input and chroma output. The autocorrelation matrix is LDL decomposed and the final filter coefficients are calculated using back-substitution. The process follows the calculation of the Adaptive Linear Filtering (ALF) filter coefficients in ECM, except that LDL decomposition is chosen instead of Cholesky decomposition to avoid using square root operations. The calculation uses only integer arithmetic.

Note that a single model or multi-model variant of CCCM can be used. The multi-model variant uses two models, one model derived for samples above the average luma reference value and another model for the rest of the samples. Multi-model CCCM mode can be selected for Coding Units (CUs) containing at least 128 available decoded reference samples.

Note also that the term “reference area” has been chosen to match the standard nomenclature of CCCM. But a reference area of a given CB is equivalent to the template of this CB.

Note that CCCM is not included in the intra prediction mode signaling in chrominance because CCCM is currently studied in EE, thus not yet part of ECM.

As described above, DIMD, TIMD, and CCCM are new intra prediction modes based on templates. This means that DIMD, TIMD, and CCCM completely determine the intra prediction model for predicting a given block. Note that TIMD can be combined with MRL and ISP. Therefore, for a given luminance CB, TIMD fully determines the intra prediction model for predicting this CB (the combination of intra prediction modes and potentially the mode blending), this model being optionally duplicated on sub-partitions of this CB, and this model optionally using another line of decoded reference samples.

In contrast, in this disclosure, the template of a given luminance CB defines the filtering, which is to be applied to the prediction of this CB generated using a given intra prediction mode. In other words, this disclosure proposes a method to smooth the signal in order to improve the prediction to quality (similar to the purpose of PDPC). Differently from PDPC in which the decision of turning the filtering on/off and the filtering behavior only depends on the size of the current luminance CB and the index of the intra prediction mode predicting the current luminance CB, in this disclosure, the parametrization of the filtering depends on the intensities of decoded reference samples in the template of the current luminance CB.

### Filtering of Luma Intra Prediction Learned on the Template

For a given W×H luminance CB to be encoded/decoded and predicted via a given intra prediction mode, the proposed filtering of the prediction of this CB is decomposed into two steps: the learning of the filter and the application of the learned filter to the prediction of this CB. It should be noted that the proposed method of filtering of intra prediction can also be applied to the chroma components.

### Learning the Filter

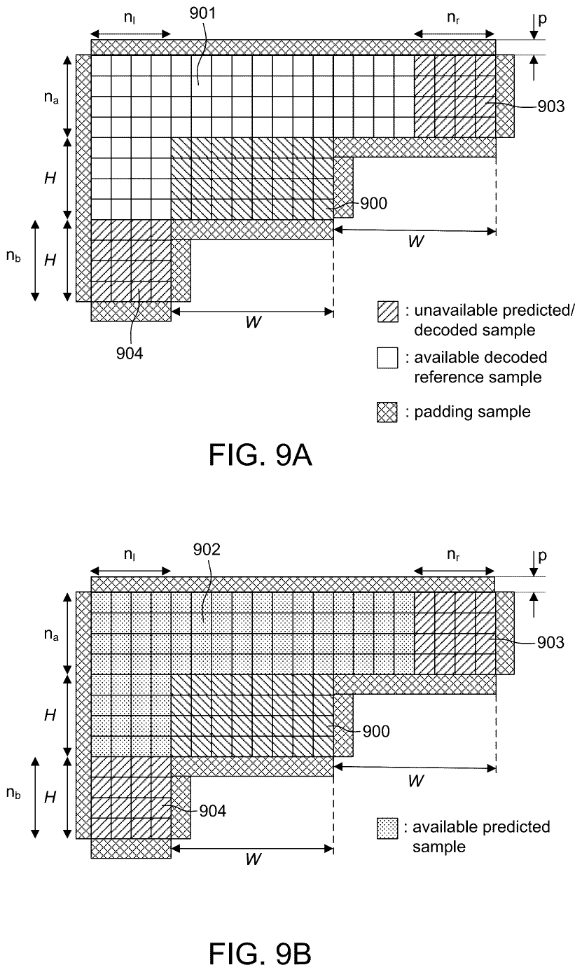

FIG. 9A and FIG. 9B illustrate the template of predicted samples (902) and the template of decoded reference samples (901) of the current W×H luminance CB (900) to be encoded/decoded.

The current W×H luminance CB (900), as illustrated in FIG. 9A, has a first template (901), made of nₐ rows of decoded reference samples located above the current luminance CB and nₗ columns of decoded reference samples located on the left side of the current luminance CB. The template area can be in other shapes or sizes, and in general can be any reconstructed area close to the current block. The current luminance CB also has a second template (902), made of nₐ rows of predicted samples located above the current luminance CB and nₗ columns of predicted samples located on the left side of the current luminance CB. The predicted samples in the second template are obtained based on the given intra prediction mode. That is, the intra prediction is performed, with the selected intra prediction direction, on the template area. The reference samples used for prediction can be the same for the current block, or can be new reference samples above and on the left of the template.

At the encode side, multiple intra prediction modes may be tested to select an intra prediction mode to be actually used for encoding the block. If the proposed filtering is enabled for a potential intra prediction mode, the predicted samples in the second template are obtained based on that potential intra prediction mode. Thus, when the filtering is allowed for multiple potential intra prediction modes, the predicted samples are generated for each of these potential intra prediction modes during the intra mode decision process. At the decoder side, the intra prediction mode is decoded explicitly from the bitstream or decoded implicitly, and the predicted samples for the second template are obtained based on the decoded intra prediction mode.

Given the encoding/decoding partitioning history leading to the encoding/decoding of the current luminance CB, the first template (901) of decoded reference samples may be adjusted such that the unavailable decoded reference samples are excluded from (901). The second template (902) of predicted samples may be adjusted the same way, i.e., the unavailable predicted samples are excluded from (902). For instance, in FIG. 9A, (901) is adjusted to exclude the n_{b}∈[0, H] rows (904) of unavailable decoded reference samples at its bottom and the nᵣ∈[0, W] columns (903) of unavailable decoded reference samples at its right-hand side. Similarly, in FIG. 9B (902) is adjusted to exclude the n_{b}∈[0, H] rows (904) of unavailable predicted samples at its bottom and the nᵣ∈[|0, W|] columns (903) of unavailable predicted samples at its right-hand side. In general, the first template of decoded reference samples and the second template of predicted samples cover the same area in a picture.

Then, different possible filter parameters are tested to select the filter parameters θ. In particular, a possible filter parameter is applied to the second template of the predicted samples. The difference (e.g., MSE) between the filtered predicted samples and the decoded reference samples is calculated. The filter parameters θ may be learned by minimizing the MSE between the filtered luma samples in the template of predicted samples (902) and the decoded reference samples in the template of decoded reference samples (901). If needed, the template of decoded reference samples (901) and the template of predicted samples (902) may be padded the same way, using a padding border of p pixels, as shown in FIG. 9. The padding may consist in filling the padding area with a given value. Alternatively, the padding may consist in copying into a given sample to be padded the value of an available spatially neighboring sample.

### Application of the Filter to the Prediction of the Current Luminance CB

The filter of learned parameters θ may apply to the prediction of the current luminance CB, where the prediction is generated using the given intra prediction mode.

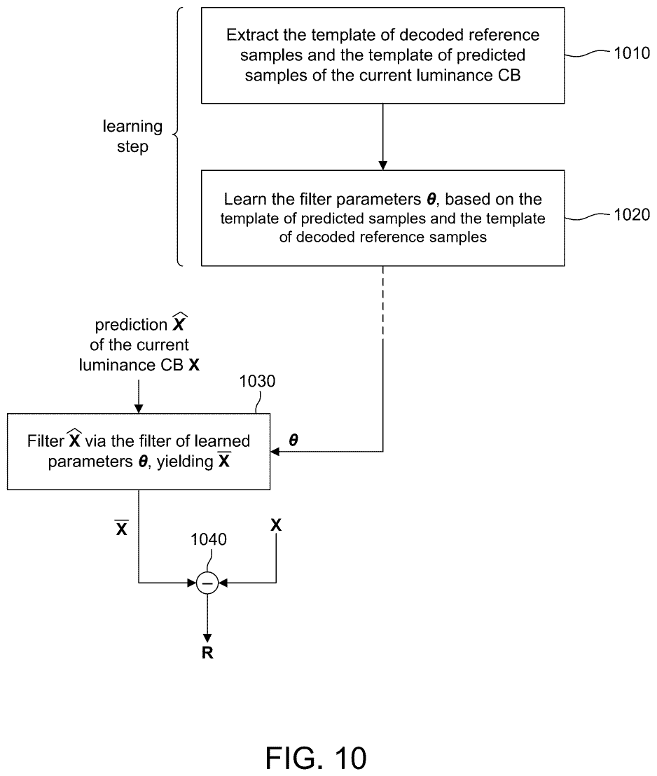

FIG. 10 illustrates two-step template-based filtering of the luma intra prediction on the encoder side, for the current luminance CB predicted in an intra mode, according to an embodiment.

In FIG. 10, the dotted line indicates that, on the encoder side, the learning step must be carried out before running the filtering of the prediction of the current luminance CB but not necessarily right before. Indeed, several processes may be placed between the learning step and the filtering of the prediction of the current luminance CB. For instance, as soon as the template of decoded reference samples, is reconstructed, for the current luminance CB, the learning step may be done.

In particular, at step 1010, the encoder extracts the template of decoded reference samples from the neighboring reconstructed regions of the current block, and the encoder also obtains the template of predicted samples for the current block. Then, the current luminance CB may be predicted using the given intra prediction mode. At step 1020, based on the template of decoded reference samples and the template of predicted samples, the filter parameters θ is learned.

As described above, the predicted samples in the second template can be generated by using the given intra prediction mode (the one used for the current block). Alternatively, to save computation, the predicted samples may be extracted from the template area, namely, the predicted samples (based on the intra prediction mode used to encode/decode a neighboring block) for the neighboring block are stored and can be extracted directly to be used in the second template.

Then, the filtering of the current luminance CB may be performed (1030) on the prediction \hat{X} of the current block, yielding the filtered prediction X̅. The difference between the filtered prediction (X̅) and the original block (X) is calculated (1040) to obtain the prediction residuals. The residuals can then be quantized, transformed and entropy coded as illustrated in FIG. 2.

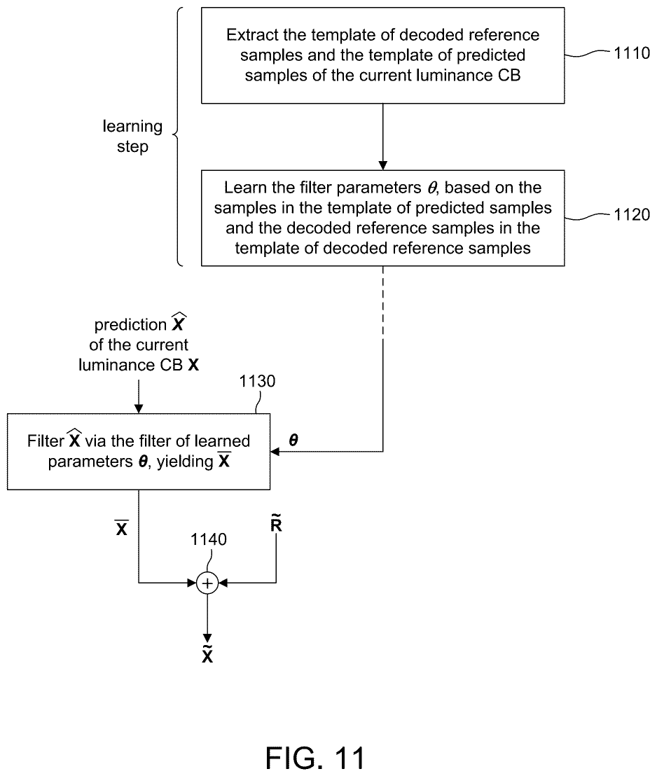

FIG. 11 illustrates two-step template-based filtering of the luma intra prediction on the decoder side, for the current luminance CB predicted in intra, according to an embodiment.

Similar to the encoder side, in FIG. 11, the dotted line indicates that, on the decoder side, the learning step must be carried out before launching the filtering of the prediction of the current luminance CB but not necessarily right before.

In particular, at step 1110, the decoder extracts the template of decoded reference samples from the neighboring decoded regions of the current block, and the decoder also obtains the template of predicted samples for the current block. The templates are generated in the same manner as in the encoder side. Then, the current luminance may be predicted by using the decoded intra prediction mode. At step 1120, based on the template of decoded reference samples and the template of predicted samples, the filter parameter θ is learned.

Then, the filtering of the current luminance CB may be performed (1130) on the prediction \hat{X} of the current block, yielding the filtered prediction X̅. The reconstructed residue (\tilde{R}) of the current luminance CB, coming from the inverse transform, is combined (1140) with the filtered prediction (X̅) to form the reconstructed current luminance CB (\tilde{X}). The reconstructed block can be further filtered as illustrated in FIG. 3.

Filter being a Convolutional 7-Tap Filter as in CCCM

In this embodiment, the filter may be a convolutional 7-tap filter as in CCCM. In this case, the input to the spatial 5-tap component of the filter may consist of a center (C) luma predicted sample and its above/north (N), below/south (S), left/west (W), and right/east (E) neighbors. Moreover, θ={c₀, c₁, c₂, c₃, c₄, c₅, c₆}. The definitions of the non-linear term and the bias term may follow those described for CCCM. Any other definition for the non-linear term or the bias term may also apply.

Filter being a Convolutional 5-Tap Filter

In this embodiment, the filter may be a convolutional 5-tap filter. This case may amount to the case presented for CCCM, but removing the non-linear term and the bias term. θ={c₀, c₁, c₂, c₃, c₄}.

### Filter Consisting of a Single Weight and a Single Bias

In this embodiment, the filter may consist in a single weight a and a single bias b. In this case, the relationship between an input predicted x̅ luma sample and an output filtered luma sample \tilde{x} is: \tilde{x}=ax̅+b. θ={a,b}.

Filter being a Piecewise Linear Function

In this embodiment, the filter may be a piecewise linear function ƒ with ρ∈ [symbol] pieces. Note that, as a piecewise linear function may be expressed under different forms, its set of parameters may take different forms. For instance, a piecewise linear function may be expressed by giving the linear piece of index i a slope αᵢ and an offset βᵢ and pre-defining its bounds (bᵢ, bᵢ₊₁). In this case, θ={(αᵢ, βᵢ)}_{i∈[0,ρ-1]}. For instance, if ρ=4, b₀=0, b₁=120, b₂=570, b₃=1003, b₄=1024, for a given input predicted luma sample x̅ and its output filtered version \tilde{x},

$$\tilde{x} = f ( \overline{x} ; θ ) = \{ \begin{matrix}{α}_{0} \overline{x} + {β}_{0} & if \overline{x} ∈ [ 0 , 120 ) \\ {α}_{1} \overline{x} + {β}_{1} & if \overline{x} ∈ [ 120 , 570 ) \\ {α}_{2} \overline{x} + {β}_{2} & if \overline{x} ∈ [ 570 , 1003 ) \\ {α}_{3} \overline{x} + {β}_{3} & if \overline{x} ∈ [ 1003 , 1024 )\end{matrix}$$

### Reduced Template Size

A larger template size corresponds to higher complexity at both the encoder and decoder sides. Additionally, a larger template contains decoded pixels that are far from the current block. That is why these decoded pixels and the pixels of the current block are likely to exhibit different statistical properties. Therefore, the trained filter coefficients will probably not be optimal for improving the prediction of the current block.

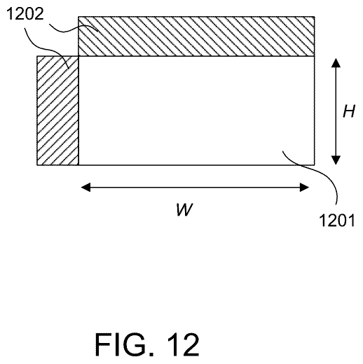

In template-based intra coding (DIMD and TIMD), the template for deriving intra prediction modes indices contains 2 to 4 lines of decoded pixels. FIG. 12 illustrates a template shape for TIMD and possibly for deriving the intra filter. The current W×H block (1201) has a template (1202) made of two pieces.

In TIMD, the template shape, shown in FIG. 12 is optimal for capturing the local statistics of the current block. The same template shape may be used for the proposed intra filtering derivation. However, in one example, the template size should be larger or equal to 3 for better applicability of the filter, which requires accessing the surrounding pixels.

### Reduced Number of Filters

The encoder may be required to derive the intra filter coefficients for each tested intra prediction mode. Thus, for a given luma block to be encoded, this possibly requires deriving 67 filters at the encoder side, which significantly increases the encoder running time.

In order to reduce this complexity, the following is proposed:
1. The intra filtering only applies when a MPM belonging to the primary list of MPMs is used to predict the current luma block. That is, only 6 filters need to be trained for coding a given luma block at the encoder side. This also reduces the signaling overhead as the intra filtering is only used when a MPM belonging to the primary list of MPMs is selected.
2. Extension of Point 1 to both the primary list of MPMs and the secondary list of MPMs. For a given luma block, the coefficients of a filter must be learned for each of the additional 16 intra prediction modes belonging to the secondary list of MPMs.
3. Grouping of intra modes: e.g. training for horizontal, vertical, diagonal, and anti-diagonal directional intra prediction modes. That is, a given intra prediction mode is grouped to one of the four groups of directional intra prediction modes, and a single filter is trained per group. The same idea can be used by grouping neighboring intra prediction modes into one mode.

### Intra Filtering for TIMD/DIMD

In this embodiment, instead of training the filter for each intra prediction mode, the filter training can be only performed for TIMD/DIMD modes. That is, when TIMD/DIMD is invoked to deduce the best intra prediction modes indices, the corresponding filter is trained. This embodiment has two advantages:
1. Reduced encoder complexity. This is because the filter training is only performed for DIMD/TIMD modes instead of the full 67 intra prediction modes.
2. Reduced signaling. This is because the DIMD/TIMD flag can be used to indicate that the filter is used. That is, whenever DIMD/TIMD is signaled, the decoder infers that the intra filter is used.

### Blending Original and Filtered Prediction

The filter parameters are trained from pairs of a predicted sample and a reconstructed sample that are close to the current luma block upper and left boundaries. This makes the filter more efficient at improving the prediction in this area rather than the lower bottom area of the current luma block. Therefore, it is proposed to gradually switch from the filtered prediction towards the regular prediction. This can be done via a blending process that merges the original prediction (PredOrg) and filtered prediction (PredFil) such that the final prediction (PredFin) is

$$PredFin ( i , j ) = M ( i , j ) * PredFil ( i , j ) + ( 1 - M ( i , j ) ) * PredOrg ( i , j )$$

where M(i,j) is the blending function that starts with 1 and gradually goes to zero as i and j increase.

### Intra Filtering for Similar Neighboring Intra Prediction Modes

In this embodiment, the intra filtering may only apply if, for at least one block overlapping the template of the current luma block to be encoded/decoded, the intra prediction selected mode (the mode whose index is signaled in the bitstream to the decoder side) to predict this block is a close neighbor of the selected intra prediction mode to predict the current luma block. A block is considered to overlap with the template if some or all samples of the block are included in the template area. For example, there may exist a function isClose( [symbol] ᵢ, [symbol] _{c}) returning true if the intra prediction mode of index [symbol] ᵢ selected to predict the block Bᵢ overlapping the template of the current luma block is a close neighbor of the intra prediction mode of index [symbol] _{c} selected to predict the current luma block. For instance, isClose( [symbol] ᵢ, [symbol] _{c})=| [symbol] ᵢ− [symbol] _{c}|_{%}<σ, σ∈[0,66], |.−.|_{%} being a circular distance.

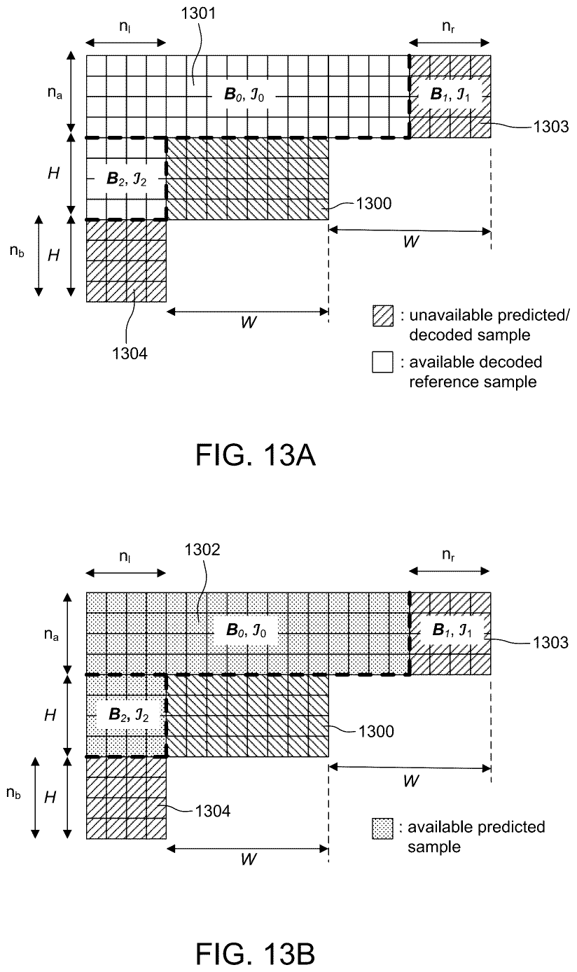

In FIG. 13A and FIG. 13B, the template of predicted samples (1302) and template of decoded reference samples (1301) of the current W×H luminance CB (1300) to be encoded/decoded comprise three blocks B₀, B₁, and B₂. Each block Bᵢ is associated with its selected intra prediction mode (the mode whose index is signaled in the bitstream to the decoder side) of index [symbol] ᵢ. No padding sample for the templates of the current luminance CB is displayed for readability.

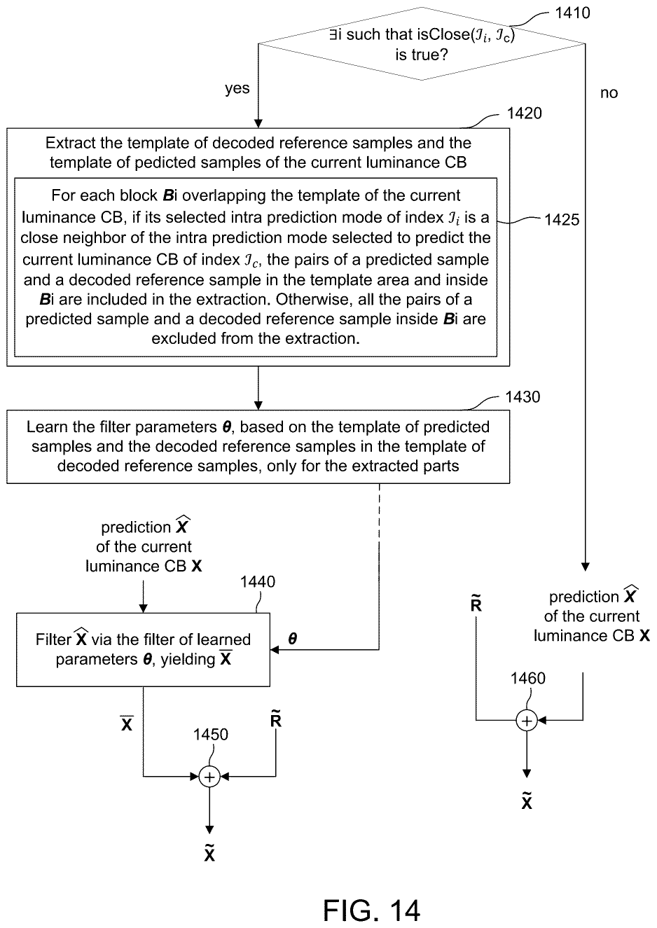

FIG. 14 illustrates two-step template-based filtering of the luma intra prediction on the decoder side, for the current luminance CB predicted in intra, according to this embodiment. \tilde{R} denotes the reconstructed residue of the current luminance CB, coming from the inverse transform. \tilde{X} denotes the reconstructed current luminance CB.

For a given intra prediction mode of index [symbol] _{c} used to predict the current luminance CB, if isClose( [symbol] ₀, [symbol] _{c}) and isClose( [symbol] ₁, [symbol] _{c}) and isClose( [symbol] ₂, [symbol] _{c}) return false (1410), no learning of the filter coefficients is carried out and the prediction of the current luminance CB is not filtered. As illustrated in FIG. 14, the prediction of the current block (\hat{X}) is combined (1460) with reconstructed residue (\tilde{R}) of the current block to form the reconstructed current luminance CB (\tilde{X}).

Otherwise, if isClose( [symbol] ₀, [symbol] _{c}), isClose( [symbol] ₁, [symbol] _{c}), or isClose( [symbol] ₂, [symbol] _{c}) returns true (1410), at step 1420, the decoder extracts the template of decoded reference samples from the neighboring decoded regions of the current block, and the decoder also obtains the template of predicted samples for the current block. For each block Bᵢ overlapping the template of the current luminance CB, if its selected intra prediction mode of index [symbol] ᵢ is a close neighbor of the intra prediction mode selected to predict the current luminance CB of index [symbol] _{c}, the predicted samples and a decoded reference sample in the template area and inside Bᵢ are included in the extraction (1425). Otherwise, all the predicted samples and decoded reference samples inside Bᵢ are excluded from the extraction (1425).

At step 1430, based on the template of decoded reference samples and the template of predicted samples, the filter parameter θ is learned. Then, the filtering of the current luminance CB may be performed (1440) on the prediction \hat{X} of the current block, yielding the filtered prediction X̅. The reconstructed residue (\tilde{R}) of the current luminance CB is combined (1450) with the filtered prediction (X̅) to form the reconstructed current luminance CB (\tilde{X}). The reconstructed block can be further filtered as illustrated in FIG. 3.

FIG. 14 is described with respect to the decoder side. At the encoder side, steps similar to 1410, 1420, 1430 can be performed to adjust the template area and learn the filter parameter.

According to an embodiment, the proposed filtering of the prediction of the current luminance CB generated via a given intra prediction mode may be allowed if this given intra prediction mode is a core intra prediction mode (i.e., either PLANAR or DC or a directional intra prediction mode) and MRL and ISP are not used. In particular, according to this embodiment, the proposed filtering of the prediction of the current luminance CB generated via a given intra prediction mode is not allowed if this given mode is a MIP mode.

According to an embodiment, the proposed filtering of the prediction of the current luminance CB generated via a given intra prediction mode may be allowed if this given intra prediction mode is a core intra prediction mode (i.e., either PLANAR or DC or a directional intra prediction mode) and MRL is not used. In this case, if ISP is used, the process of learning the filter parameters and applying the learned filter to the prediction of the current luminance block may be reiterated for each luminance Transform Block (TB) inside the current luminance CB.

In this case, the method proceeds similarly to the one in FIG. 14, except that the method is performed at the TB level.

This embodiment features two main advantages. Firstly, on the encoder side, for a given luma block to be encoded, the learning of the filter coefficients is carried out for each intra prediction mode belonging to a small subset of all the tested intra prediction modes. This reduces the complexity of the proposed method on the encoder side. Secondly, the proposed filtering incurs no additional signaling as the intra prediction modes selected to predict the blocks overlapping the template of the current luma block to be encoded/decoded defines whether the proposed filtering applies.

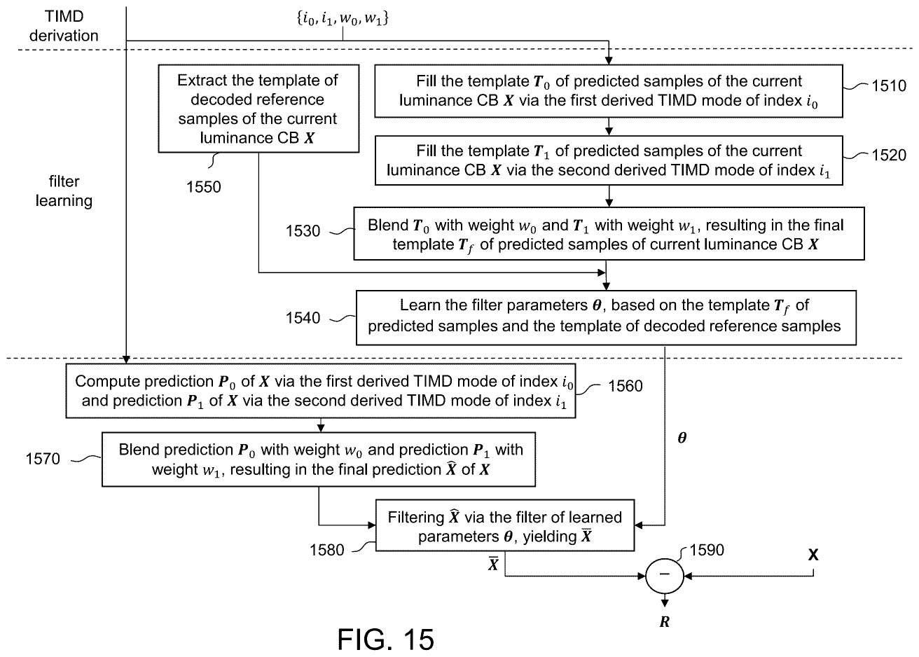

FIG. 15 illustrates a method of filtering the prediction of the current luminance CB using a learned filter at the encoder side, according to an embodiment. This embodiment can apply to the case where the template of predicted samples is obtained by applying the intra prediction tool selected to predict the current luminance CB on the template area, and may be especially relevant given its small complexity overhead.

In this embodiment, for the current luminance CB selecting TIMD for intra prediction, after completing the TIMD derivation step, at the filter learning step, the indices of the derived TIMD modes and the derived TIMD weights may be used to generate the template of predicted samples of the current luminance CB.

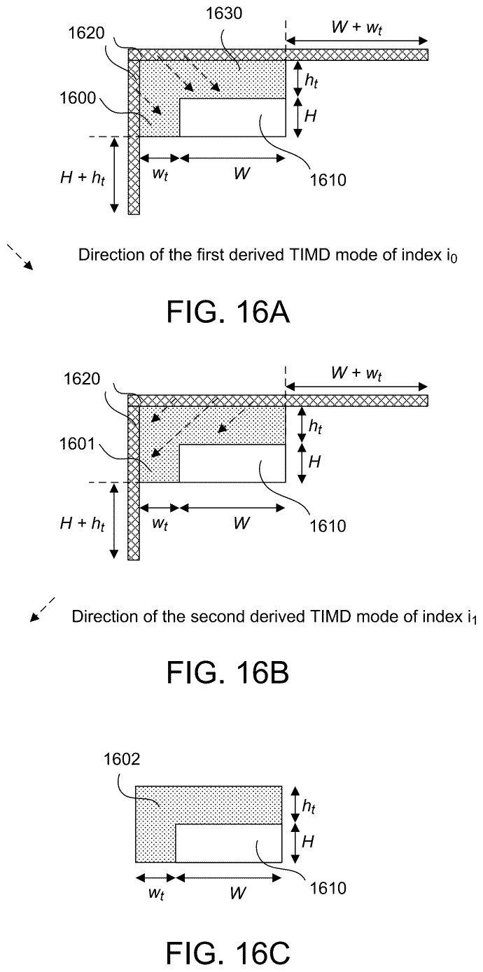

In particular, FIG. 15 depicts this embodiment for the current W×H luminance CB selecting TIMD for intra prediction on the encoder side. FIG. 15 assumes that, in TIMD, two intra prediction modes are derived as shown in an example in FIG. 16, as in ECM-4.0. The TIMD derivation step returns the first derived TIMD mode of index i₀, the second derived TIMD mode of index i₁, and their respective weights w₀ and w₁. If, as in ECM-4.0, the allowed directional intra prediction modes for TIMD correspond to the set of directional intra prediction modes being twice denser than that in VVC, (i₀, i₁)∈( [symbol] 0, 130 [symbol] )². If the weight normalization in ECM-4.0 is used, w₀ and w₁ are positive and w₀+w₁=64.

Referring back to FIG. 15, at 1510, the decoded reference samples (1620) are used by the first derived TIMD mode of index i₀ to fill the template T₀ (1600) of predicted samples of the current W×H luminance CB (1610). This may be done by extrapolating the decoded reference samples into T₀ following the direction of mode of index i₀. At 1520, the decoded reference samples (1620) are used by the second derived TIMD mode of index i₁ to fill the template T₁ (1601) of predicted samples of the current W×H luminance CB (1610). This may be done by extrapolating the decoded reference samples into T₁ following the direction of mode of index i₁. At 1530, the blending of T₀ with weight w₀ and T₁ with weight w₁ produces the final template T_{ƒ} (1602) of predicted samples of the current W×H luminance CB (1610). For instance, the blending may be given by the following equation:

$${T}_{f} ( x , y ) = ( {w}_{0} {T}_{0} ( x , y ) + {w}_{1} {T}_{1} ( x , y ) + 32 ) >> 6$$

where (x, y) denotes the coordinate of the current predicted sample inside T_{ƒ}.

At 1550, the template (1630) of decoded reference samples of the current luminance CB (1610) is extracted. At 1540, based on the template (1602) of predicted samples and the template (1630) of decoded reference samples, the filter parameters θ are learned. At 1560, prediction P₀ of X via the first derived TIMD mode of index i₀ is computed, and prediction P₁ of X via the second derived TIMD mode of index i₁ is computed. At 1570, the blending of P₀ with weight w₀ and P₁ with weight w₁ returns the prediction \hat{X} of the current luminance CB X. For instance, the blending may be written as \hat{X}(x, y)=(w₀P₀(x, y)+w₁P₁(x, y)+32)>>6, where (x, y) denotes the coordinate of the current predicted sample inside the predicted block \hat{X}. At 1580, \hat{X} is filtered using the learned parameters θ, yielding the filtered prediction X̅ of the current luminance CB. Finally, X̅ is subtracted (1590) from X, which provides a residue R to be further encoded.

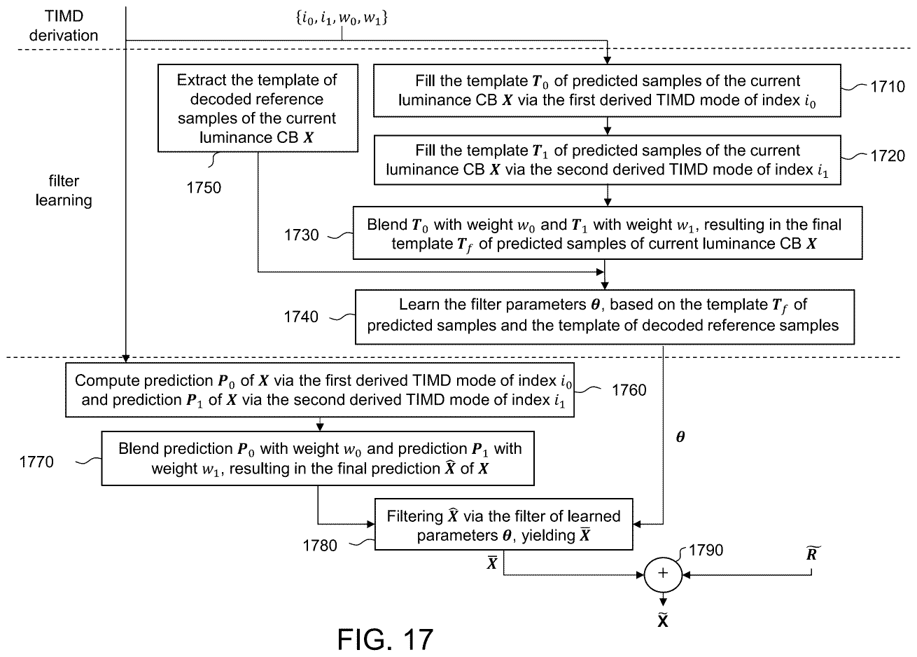

FIG. 17 illustrates a method of filtering the prediction of the current luminance CB using a learned filter at the decoder side, corresponding to the method for the encoder illustrated in FIG. 15. As for FIG. 15, FIG. 17 assumes that, in TIMD, two intra prediction modes are derived. Steps 1710, 1720, 1730, 1740, 1750, 1760, 1770, and 1780 in FIG. 17 are identical to Steps 1510, 1520, 1530, 1540, 1550, 1560, 1570, and 1580, respectively, in FIG. 15. Finally, X̅ is added (1790) to a reconstructed residue \tilde{R}, which gives a reconstruction \tilde{X} of the current luminance CB.

In this embodiment presented in FIG. 15 and FIG. 17, during the filter learning step, the template (1602) of predicted samples around the current W×H luminance CB may comprise the two template portions used during the TIMD derivation step. For instance, during the TIMD derivation step, the template area for computing the SATD of prediction of each tested intra prediction mode may be made of the W×hₜ template portion located above the current W×H luminance CB and the wₜ×H template portion located on the left side of the current W×H luminance CB. During the filter learning step, the template (1602) of predicted samples may include the W×hₜ template portion located above the current W×H luminance CB, the wₜ×H template portion located on the left side of the current W×H luminance CB, and the wₜ×hₜ portion located on the above-left side of the current W×H luminance CB. This way, the prediction of the two template portions via each of the two derived TIMD modes during the TIMD derivation step may be re-used during the filter learning step. This saves computation time. Another advantage of this design lies in the fact that exactly the same decoded reference samples (1620) can be used in the TIMD derivation step and the filter learning step. Because of this, there is no need for additional memory buffers to store different decoded reference samples for the TIMD derivation step and the filter learning step.

In FIG. 15 and FIG. 17, two intra prediction modes are derived in TIMD as in ECM-4.0. However, the methods may be applied to the case where n∈ [symbol] and n>2 intra prediction modes are derived.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the intra prediction modules (260, 360), of a video encoder 200 and decoder 300 as shown in FIG. 2 and FIG. 3. Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video decoding, comprising:
obtaining an intra prediction mode for a block to be decoded in a picture;
obtaining a prediction block for said block based on said intra prediction mode for said block;
obtaining a set of decoded samples in an area neighboring to said block;
obtaining a set of predicted samples in said area neighboring to said block;
obtaining one or more filter parameters for a filter based on said set of decoded samples and said set of predicted samples in said area neighboring to said block;
applying said filter to said prediction block for said block to form a filtered prediction block for said block; and
decoding said block based on said filtered prediction block for said block.

2-3. (canceled)

4. The method of claim 1, wherein at least two intra prediction modes are obtained for said block based on template-based intra mode derivation, wherein at least two respective predictors are formed for said block, corresponding to said at least two intra prediction modes for said block, and blended to form said prediction block for said block, and wherein at least another two respective predictors are formed for said area neighboring to said block, corresponding to said at least two intra prediction modes for said block, and blended to form said set of predicted samples in said area neighboring to said block.

5. The method of claim 4, wherein at least part of prediction in said template-based intra mode derivation is re-used when forming said at least another two predictors for said area neighboring to said block.

6-10. (canceled)

11. The method of claim 1, wherein said prediction block is filtered responsive to said intra prediction mode belonging to a list of Most Probable Modes (MPMs).

12-13. (canceled)

14. The method of claim 1, further comprising:
determining a group of intra prediction modes to which said intra prediction mode of said block belongs, wherein a single filter is obtained for said group of intra prediction modes.

15. The method of claim 1, wherein said filter is only applied when TIMD (Template-based Intra Mode Derivation) is invoked.

16. The method of claim 1, wherein said filter is only applied when DIMD (Decoder-side Intra Mode Derivation) is invoked.

17. The method of claim 1, further comprising blending said prediction block and said filtered prediction block.

18. The method of claim 1, further comprising:
obtaining an intra prediction mode selected to predict a portion in said area neighboring to said block,
wherein said portion is included in said area neighboring to said block only responsive to that said selected intra prediction mode for said portion is a close neighbor of said intra prediction mode of said block.

19. (canceled)

20. An apparatus for video decoding, comprising one or more processors and at least one memory, wherein said one or more processors are configured to:
obtain an intra prediction mode for a block to be decoded in a picture;
obtain a prediction block for said block based on said intra prediction mode for said block;
obtain a set of decoded samples in an area neighboring to said block;
obtain a set of predicted samples in said area neighboring to said block;
obtain one or more filter parameters for a filter based on said set of decoded samples and said set of predicted samples in said area neighboring to said block;
apply said filter to said prediction block for said block to form a filtered prediction block for said block; and
decode said block based on said filtered prediction block for said block.

21-22. (canceled)

23. The apparatus of claim 20, wherein at least two intra prediction modes are obtained for said block based on template-based intra mode derivation, wherein at least two respective predictors are formed for said block, corresponding to said at least two intra prediction modes for said block, and blended to form said prediction block for said block, and wherein at least another two respective predictors are formed for said area neighboring to said block, corresponding to said at least two intra prediction modes for said block, and blended to form said set of predicted samples in said area neighboring to said block.

24. The apparatus of claim 23, wherein at least part of prediction in said template-based intra mode derivation is re-used when forming said at least another two predictors for said area neighboring to said block.

25. (canceled)

26. The apparatus of claim 20, wherein said one or more processors are further configured to:
determine a group of intra prediction modes to which said intra prediction mode of said block belongs, wherein a single filter is obtained for said group of intra prediction modes.

27. The apparatus of claim 20, wherein said filter is only applied when TIMD (Template-based Intra Mode Derivation) is invoked.

28. The apparatus of claim 20, wherein said filter is only applied when DIMD (Decoder-side Intra Mode Derivation) is invoked.

29-30. (canceled)

31. A method of video encoding, comprising:
obtaining an intra prediction mode for a block to be encoded in a picture;
obtaining a prediction block for said block based on said intra prediction mode for said block;
obtaining a set of decoded samples in an area neighboring to said block;
obtaining a set of predicted samples in said area neighboring to said block;
obtaining one or more filter parameters for a filter based on said set of decoded samples and said set of predicted samples in said area neighboring to said block;
applying said filter to said prediction block for said block to form a filtered prediction block for said block; and
encoding said block based on said filtered prediction block for said block.

32. The method of claim 31, wherein at least two intra prediction modes are obtained for said block based on template-based intra mode derivation, wherein at least two respective predictors are formed for said block, corresponding to said at least two intra prediction modes for said block, and blended to form said prediction block for said block, and wherein at least another two respective predictors are formed for said area neighboring to said block, corresponding to said at least two intra prediction modes for said block, and blended to form said set of predicted samples in said area neighboring to said block.

33. The method of claim 32, wherein at least part of prediction in said template-based intra mode derivation is re-used when forming said at least another two predictors for said area neighboring to said block.

34. An apparatus for video encoding, comprising one or more processors and at least one memory, wherein said one or more processors are configured to:
obtain an intra prediction mode for a block to be encoded in a picture;
obtain a prediction block for said block based on said intra prediction mode for said block;
obtain a set of decoded samples in an area neighboring to said block;
obtain a set of predicted samples in said area neighboring to said block;
obtain one or more filter parameters for a filter based on said set of decoded samples and said set of predicted samples in said area neighboring to said block;
apply said filter to said prediction block for said block to form a filtered prediction block for said block; and
encode said block based on said filtered prediction block for said block.

35. The apparatus of claim 34, wherein said one or more processors are further configured to:
determine a group of intra prediction modes to which said intra prediction mode of said block belongs, wherein a single filter is obtained for said group of intra prediction modes.
